(19) United States
(12) Patent Application Publication
(10) Pub. No.: US 2026/0189311 A1
(43) Pub. Date: Jul. 2, 2026

(54) BEAMFORMING VECTOR POWER VERIFICATION

(71) Applicant: QUALCOMM Incorporated, San Diego, CA (US)

(72) Inventors: Mustafa EMARA, Munich (DE); Vasanthan RAGHAVAN, West Windsor Township, NJ (US)

(21) Appl. No.: 19/417,119

(22) Filed: Dec. 11, 2025

Related U.S. Application Data
(60) Provisional application No. 63/739,185, filed on Dec. 27, 2024.

(51) Int. Cl. H04B 17/10; H04B 7/0426; H04B 17/00; H04B 17/12

(52) U.S. Cl. CPC H04B 17/102; H04B 7/043; H04B 17/0085; H04B 17/12

(57) ABSTRACT

Methods, systems, and devices for wireless communications are described. A testing device may output an indication of multiple steering directions to a network entity. Multiple beamforming vectors corresponding to regions within a coverage angular region (CAR) of the network entity may be based on the multiple steering directions. For each region, a respective steering direction of the multiple steering directions may be determined from a respective test location selected from a set of test locations on a perimeter of a subregion within each region. The testing device may measure one or more effective isotropic radiated powers (EIRPs) of beams over an elevation or an azimuth angle associated with the multiple beamforming vectors. The testing device may verify that a cumulative or expected EIRP of the beams satisfies a EIRP envelope or mask associated with the elevation or the azimuth angle.

### CROSS REFERENCES

The present application for patent claims benefit of U.S. Provisional Patent Application No. 63/739,185 by EMARA et al., entitled “BEAMFORMING VECTOR POWER VERIFICATION,” filed Dec. 27, 2024, assigned to the assignee hereof, and expressly incorporated herein.

### FIELD OF TECHNOLOGY

The following relates to wireless communications, including beamforming vector power verification.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by an apparatus is described. The method may include outputting an indication of a set of multiple steering directions to a network entity, where a set of multiple beamforming vectors corresponding to regions within a coverage angular region (CAR) of the network entity are based on the set of multiple steering directions, and where, for each region, a respective steering direction of the set of multiple steering directions is determined from a respective test location selected from a set of test locations on a perimeter of a subregion within each region, measuring one or more effective isotropic radiated powers (EIRPs) of beams over an elevation or an azimuth angle associated with the set of multiple beamforming vectors, and verifying that a cumulative or expected EIRP of the beams satisfies a EIRP envelope or mask associated with the elevation or the azimuth angle.

An apparatus is described. The apparatus may include one or more memories storing processor executable code, and one or more processors coupled with the one or more memories. The one or more processors may individually or collectively be operable to execute the code to cause the apparatus to output an indication of a set of multiple steering directions to a network entity, where a set of multiple beamforming vectors corresponding to regions within a CAR of the network entity are based on the set of multiple steering directions, and where, for each region, a respective steering direction of the set of multiple steering directions is determined from a respective test location selected from a set of test locations on a perimeter of a subregion within each region, measure one or more EIRPs of beams over an elevation or an azimuth angle associated with the set of multiple beamforming vectors, and verify that a cumulative or expected EIRP of the beams satisfies a EIRP envelope or mask associated with the elevation or the azimuth angle.

Another apparatus is described. The apparatus may include means for outputting an indication of a set of multiple steering directions to a network entity, where a set of multiple beamforming vectors corresponding to regions within a CAR of the network entity are based on the set of multiple steering directions, and where, for each region, a respective steering direction of the set of multiple steering directions is determined from a respective test location selected from a set of test locations on a perimeter of a subregion within each region, means for measuring one or more EIRPs of beams over an elevation or an azimuth angle associated with the set of multiple beamforming vectors, and means for verifying that a cumulative or expected EIRP of the beams satisfies a EIRP envelope or mask associated with the elevation or the azimuth angle.

A non-transitory computer-readable medium storing code is described. The code may include instructions executable by one or more processors to output an indication of a set of multiple steering directions to a network entity, where a set of multiple beamforming vectors corresponding to regions within a CAR of the network entity are based on the set of multiple steering directions, and where, for each region, a respective steering direction of the set of multiple steering directions is determined from a respective test location selected from a set of test locations on a perimeter of a subregion within each region, measure one or more EIRPs of beams over an elevation or an azimuth angle associated with the set of multiple beamforming vectors, and verify that a cumulative or expected EIRP of the beams satisfies a EIRP envelope or mask associated with the elevation or the azimuth angle.

Some examples of the method, apparatus, and non-transitory computer-readable medium described herein may further include operations, features, means, or instructions for outputting an indication for the network entity to transmit the set of multiple beamforming vectors.

In some examples of the method, apparatus, and non-transitory computer-readable medium described herein, the subregion within each region may be a rectangular region.

In some examples of the method, apparatus, and non-transitory computer-readable medium described herein, the set of test locations may be located in a set of multiple corners associated with the rectangular region.

In some examples of the method, apparatus, and non-transitory computer-readable medium described herein, the subregion within each region may be a curved region.

In some examples of the method, apparatus, and non-transitory computer-readable medium described herein, adjacent regions within a dimension of the regions of the CAR traverse a sequential order of the set of test locations.

In some examples of the method, apparatus, and non-transitory computer-readable medium described herein, for each region, the respective test location associated with the respective steering direction may be selected from the set of test locations pseudo-randomly.

In some examples of the method, apparatus, and non-transitory computer-readable medium described herein, the cumulative or expected EIRP may be a weighted average of the one or more EIRPs associated with the set of multiple beamforming vectors.

In some examples of the method, apparatus, and non-transitory computer-readable medium described herein, a first region of the regions includes a first subregion shape, and a second region of the regions includes a second subregion shape.

In some examples of the method, apparatus, and non-transitory computer-readable medium described herein, the set of multiple steering directions include a first set of steering directions during a first duration, and the set of multiple steering directions include a second set of steering directions during a second duration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports beamforming vector power verification in accordance with one or more aspects of the present disclosure.

FIG. 2 shows an example of a wireless communications system that supports beamforming vector power verification in accordance with one or more aspects of the present disclosure.

FIG. 3 shows an example of a coverage angular region (CAR) region configuration that supports beamforming vector power verification in accordance with one or more aspects of the present disclosure.

FIG. 4 shows an example of a CAR that supports beamforming vector power verification in accordance with one or more aspects of the present disclosure.

FIG. 5 shows an example of a process flow that supports beamforming vector power verification in accordance with one or more aspects of the present disclosure.

FIGS. 6 and 7 show block diagrams of devices that support beamforming vector power verification in accordance with one or more aspects of the present disclosure.

FIG. 8 shows a block diagram of a communications manager that supports beamforming vector power verification in accordance with one or more aspects of the present disclosure.

FIG. 9 shows a diagram of a system including a device that supports beamforming vector power verification in accordance with one or more aspects of the present disclosure.

FIGS. 10 and 11 show flowcharts illustrating methods that support beamforming vector power verification in accordance with one or more aspects of the present disclosure.

### DETAILED DESCRIPTION

In some wireless communications systems, a network entity may be tested for compliance with regulatory limitations. For example, the regulatory limitations may limit a transmit power of a device in a particular direction (e.g., in a particular elevation or azimuth angle). The regulatory limitation may reduce interference between network entities. In testing scenarios, a coverage angular region (CAR) of the network entity may be subdivided into one or more regions. Each region may cover a range of elevation and azimuth angles. The network entity may transmit a beam in accordance with a beamforming vector over each region of the one or more regions. The beamforming vector may be based on a testing location in the region and a steering direction. A testing device may measure and verify that a transmit power of the beam satisfies the regulatory limitations. Depending on the testing location and steering direction chosen in the testing scenario, the testing scenario may pessimistically or optimistically capture the true interference level of the network entity in a deployment scenario. Randomly selecting testing locations may increase a testing complexity of the testing scenario. It may be beneficial for testing scenarios to select testing locations and steering directions efficiently and fairly to ensure that network entities are in compliance with regulatory limitations.

According to techniques described herein, a network entity may transmit one or more beams in accordance with one or more beamforming vectors at the one or more regions, where each region includes a respective set of test locations on a perimeter of a subregion within the respective region. The subregion may be selected based on a distance between the perimeter of the region and the center of the region (e.g., to accurately capture the interference of the beamforming vector). A testing device may measure one or more effective isotropic radiated powers (EIRPs) of beams over an elevation or an azimuth angle. The testing device may verify that a cumulative or expected EIRP of the beams satisfies a EIRP envelope or mask associated with the elevation or the azimuth angle.

Aspects of the disclosure are initially described in the context of wireless communications systems, CAR region configurations, CARs, and process flows. Aspects of the disclosure are further illustrated by and described with reference to apparatus diagrams, system diagrams, and flowcharts that relate to beamforming vector power verification.

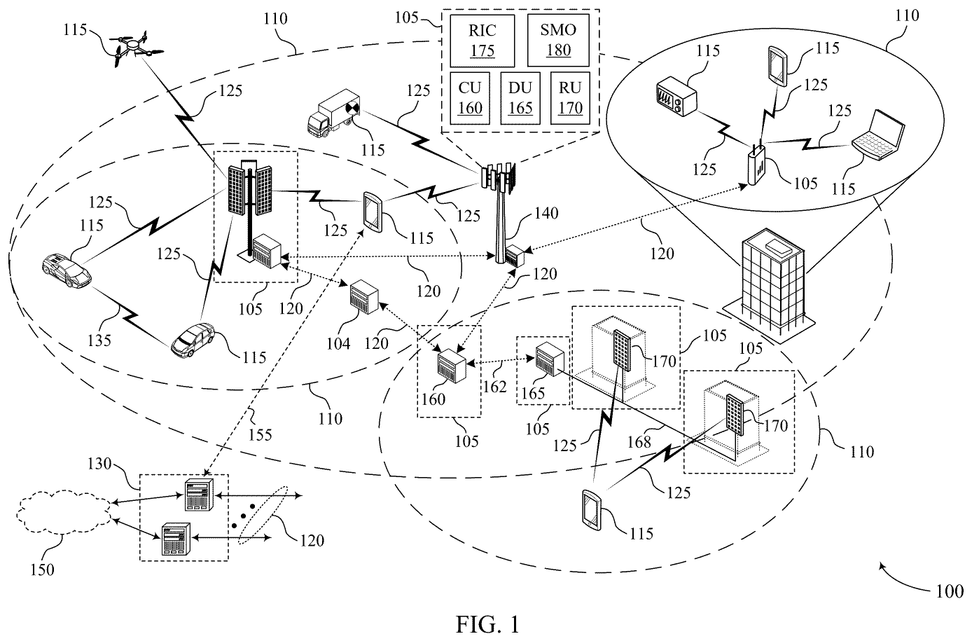

FIG. 1 shows an example of a wireless communications system 100 that supports beamforming vector power verification in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support beamforming vector power verification as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

According to techniques described herein, a network entity 105 may transmit one or more beams in accordance with one or more beamforming vectors at one or more regions of a CAR. Each region includes a respective set of test locations on a perimeter of a subregion within the respective region. The subregion may be selected based on a distance between the perimeter of the region and the center of the region (e.g., to accurately capture the interference of the beamforming vector). A testing device may measure one or more EIRPs of beams over an elevation or an azimuth angle associated with the one or more beamforming vectors. The testing device may verify that a cumulative or expected EIRP of the beams satisfies a EIRP envelope or mask associated with the elevation or the azimuth angle.

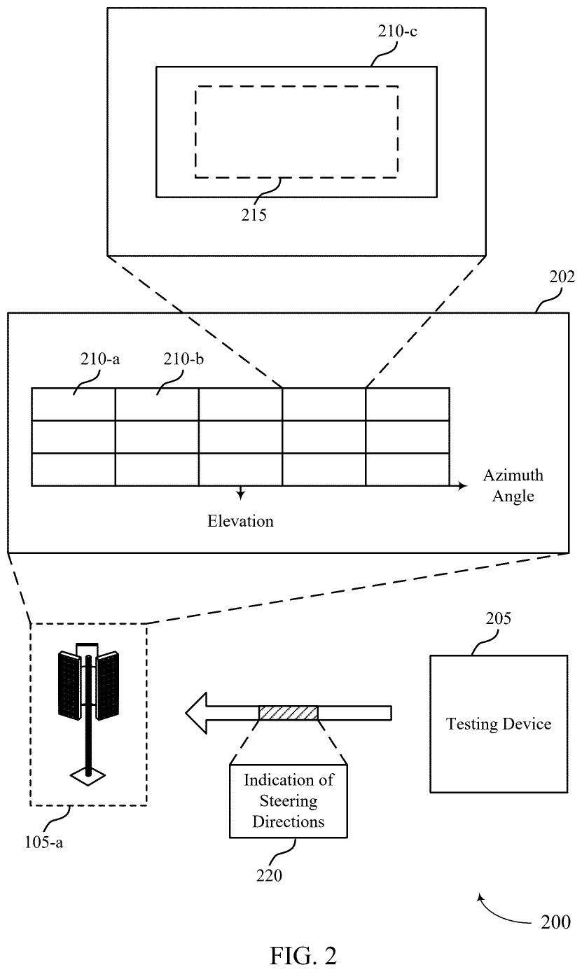

FIG. 2 shows an example of a wireless communications system 200 that supports beamforming vector power verification in accordance with one or more aspects of the present disclosure. In some examples, wireless communications system 200 may implement aspects of wireless communications system 100. For example, a network entity 105-a may represent an example of a network entity, such as the network entity 105 described with reference to FIG. 1. The wireless communications system 200 may include a testing device 205. The testing device 205 may output an indication of steering directions 220 to the network entity 105-a, and the testing device 205 may verify that an EIRP of one or more beams output by the network entity 105-a satisfy an EIRP envelope or an EIRP mask.

Some wireless communications systems produce or experience interference. For instance, a wireless communication signal produced by one wireless device may interfere with the communications of another wireless device. Some approaches to interference management or coexistence issues may be addressed based on an EIRP mask or an EIRP envelope, which may be defined according to a worst-case or an average of emissions. An EIRP mask may provide a regulatory limitation on a quantity of transmit power that a wireless device (e.g., the network entity 105-a) is allowed to transmit in a direction or directional range (e.g., in a range of elevations or a range of azimuth angles). For transmissions over a range of elevations, for example, an EIRP mask may cap the interference experienced by satellites, drones, or other aerial objects (e.g., potential victim nodes of the interference).

Some wireless devices may produce C-band transmissions (e.g., transmissions in a frequency range up to approximately 3.98 GHz), which may create interference for radio altimeters that operate in the 4.2-4.4 GHz range. Other examples of interference may occur in other frequency ranges (e.g., frequency range 3 (FR3), 7.125-24.25 GHz, in the 7.125 to 8 GHz range, frequency range 2 (FR2), or intermediate frequencies of some FR2 services in FR3, among other examples).

One or more EIRP masks may be specified for one or more frequency ranges. For instance, FR3 may be utilized for various coexisting services, and EIRP mask definitions for such bands may be utilized to regulate transmissions for sixth generation (6G) wireless communications systems. Some aspects of FR3 transmissions or multi-panel transmissions may be considered for regulatory and compliance definitions (e.g., for EIRP mask definitions, which may be similar to, or may differ from, EIRP mask definitions for one or more other technologies or frequency ranges).

EIRP mask definitions and compliance tests may be defined to ensure that potential aggressor nodes stay compliant with the defined EIRP mask. The EIRP mask may be based on one or more parameters which may include: a quantity of beamforming vectors (K), beam weights (wₖ) over which testing may be done, a sampling grid size (N sampling points in azimuth) over which EIRP may be estimated, weights (wₙₖ) associated with each beamforming vector in EIRP computation, or any combination thereof. The EIRP mask provides permissible EIRP level (e.g., a maximum or average permissible EIRP) over a specific angle (e.g., elevation angle θ₀) and an aggressor node is expected to transmit within a prescribed specification. When transmission power is below the specifications, interference at victim nodes may be reduced.

The EIRP mask EIRP(θ₀) may be defined in accordance with Equation 1.

$$EIRP ( {θ}_{0} ) = \frac{1}{KN} {\sum }_{k = 1}^{K} {\sum }_{n = 1}^{N} {w}_{nk} * P ( {θ}_{0} , {φ}_{n} , {w}_{k} ) \qquad ( 1 )$$

In this example, the EIRP mask may be an average of the power over N azimuth angles (φₙ) with K beamforming vectors (wₖ). The average EIRP limit EIRP(θ₀) may decrease as θ₀ increases. Note that θ₀ (e.g., θ₀=0° may correspond to the north pole in a global coordinate system and may be the direction in which interference may be reduced (e.g., due to presence of potential incumbent services).

The network entity 105-a may be operable for transmission over a CAR 202. The CAR 202 may be denoted as φ_{cover} and θ_{cover} in azimuth and elevation for an active antenna system (AAS) array included in the network entity 105-a (e.g., the aggressor node). For example, the array geometry may be rectangular as illustrated in FIG. 2. As such, the CAR may be expected to be rectangular. For example, the CAR 202 may span −60° to 60° in azimuth and 90° to 110° in elevation).

The CAR 202 may be subdivided into K regions 210 (e.g., a region 210-a, a region 210-b, and a region 210-c), where K may be configured in a testing procedure. The K regions may have equal or unequal area. For example, the region 210-a may be larger, the same size as, or smaller than the region 210-b. The regions 210 may have equal area in azimuth and a different (but equal) area in elevation. For example, the region 210-a may be defined by a first range of azimuth angles and a second range of elevation angles. The first range and the second range may be different. The region 210-b may be defined by a third range of azimuth angles and a fourth range of elevation angles, where the third range may span a same quantity of azimuth angles as the first range and the fourth range may space a same quantity of elevation angles as the second range. The CAR 202 may span from

$$( - \frac{{φ}_{cover}}{2} , - \frac{{θ}_{cover}}{2} ) to ( \frac{{φ}_{cover}}{2} , \frac{{θ}_{cover}}{2} ) .$$

The azimuth range of the network entity 105-a (e.g., φ_{cover}) may be uniformly partitioned into K_{az} regions and the elevation range of the network entity 105-a (e.g., θ_{cover}) may be partitioned into Kₑₗ regions where K=K_{az}*Kₑₗ. For example, as illustrated in FIG. 2, Kₑₗ may equal 3 uniform partitions in elevation and K_{az} may equal 5 uniform partitions in azimuth. Although illustrated as 3 elevation partitions and 5 azimuth partitions, it should be understood that the CAR 202 may be partitioned into any quantity of elevation partitions and azimuth partitions (e.g., uniform or non-uniform).

One or more beamforming vectors may be specified over each of the K regions 210. A steering angle of the beamforming vectors in azimuth and elevation (e.g., scan and tilt) may be defined. The steering angle may correspond to the direction at which a peak of a beam pattern is observed.

The testing device 205 may output an indication of the steering directions 220 to the network entity 105-a. In some examples, the steering directions (e.g., steering angle) may be specified to be the center of each region 210. In some examples, the steering directions may be the closest test equipment precision or test measurement precision corresponding to the center of each region 210 (e.g., within 1-2 degree precision of the center). However, choosing the center of the region 210 may not capture the worst-case possibility for interference from a transmission from the network entity 105-a (e.g., the aggressor node). Thus, choosing the center of the region 210 may lead to a pessimistic possibility for the radiated power.

In some examples, the steering directions may be uniformly or randomly distributed within a respective subregion 215 around the center of each region 210. For example, the region 210-c may include a subregion 215, and the steering directions may be selected randomly from locations within the subregion 215. The subregion 215 may be a part of the region 210 or the whole region 210. The subregion 215 may be rectangular, as illustrated in FIG. 2, or another shape within the region 210 (e.g., circular or elliptical). However, randomly selecting the steering direction offers no structure in terms of the beams and may lead to relatively larger portions of the CAR being untested. In addition, random selection may be difficult for the testing device 205 to measure or result in inconsistent evaluations for different network entities. For example, randomly selecting the steering direction may increase testing complexity and impact performance comparisons.

In some cases, choosing the center of the region 210 may utilize more deterministic steering directions of beamforming vectors and may be more efficient to implement for infrastructure vendors (e.g., network entity 105-a vendors). However, choosing the center of the region 210 may be pessimistic in actually capturing the true interference in practical deployments. In some cases, uniformly or randomly distributed steering directions may be more random and capture the interference in a more unbiased manner (e.g., enabling stricter testing criteria for regulatory entities). However, uniformly or randomly distributing the steering directions may be more complex to implement by the infrastructure vendors in testing scenarios.

According to techniques described herein, the beamforming vectors (wₖ) used to test the network entity 105-a may be defined for the EIRP mask to provide an accurate measurement of the expected or cumulative EIRP of the network entity 105-a while being efficient to implement by infrastructure vendors. The beamforming vectors (wₖ) may be based on a quasi-random set of steering directions that may be efficient to implement by infrastructure vendors and provide unbiased interference estimation.

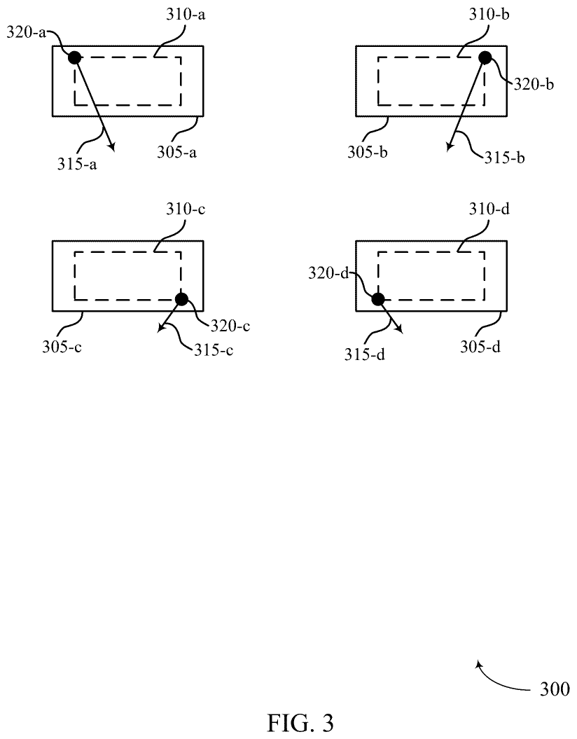

FIG. 3 shows an example of a CAR region configuration 300 that supports beamforming vector power verification in accordance with one or more aspects of the present disclosure. In some examples, CAR region configuration 300 may implement aspects of, or be implemented by aspects of, the wireless communications system 100 or the wireless communications system 200. For example, the CAR region configuration 300 may include multiple regions 305 (e.g., a first region 305-a, a second region 305-b, a third region 305-c, and a fourth region 305-d), which may be examples of regions 210 as described with reference to FIG. 2. A network entity 105 may include a CAR (e.g., the CAR 202 as described with reference to FIG. 2), and the CAR may include one or more regions 305 in accordance with the CAR region configuration 300. The network entity 105 may be an example of a network entity 105 as described with reference to FIGS. 1 and 2.

According to techniques described herein, the network entity 105 may utilize a set of steering directions 315 (e.g., a quasi-random pattern of steering vectors) over the different regions 305. Each region 305 may include a subregion 310 (e.g., a square or rectangular subregion 310). Within the rectangular subregion 310, the corner points (e.g., P=4) may be potential steering directions 315. For example, the corner points of a rectangular subregion 215 may be test locations 320 corresponding to steering directions 315.

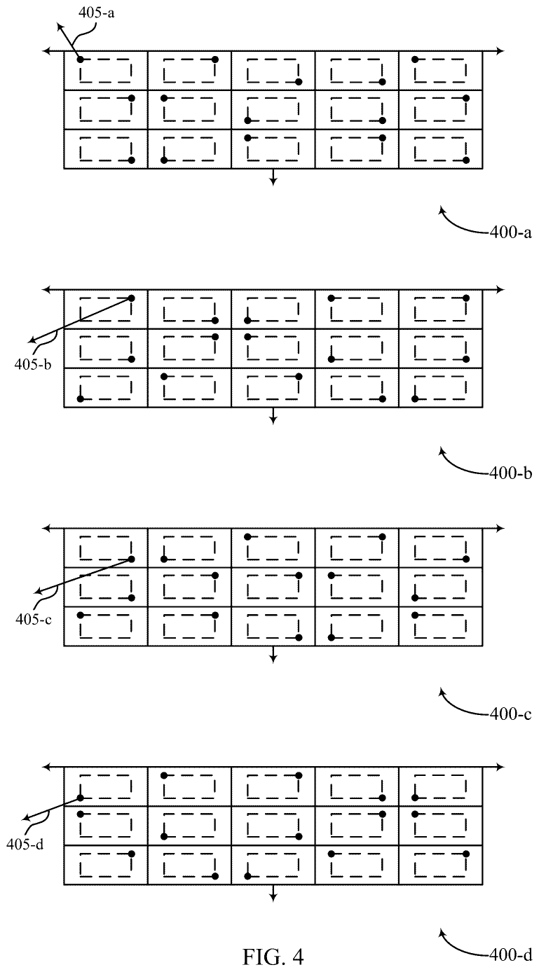

Adjacent regions 305 in the CAR may use a steering direction (e.g., one of the P steering directions). The potential steering directions may be traversed in sequential order across the adjacent regions 305. For example, the first region 305-a may use one of the P steering directions, where there may be P possibilities for steering directions over the CAR (e.g., as illustrated in FIG. 4).

The first region 305-a may include a subregion 310-a. The subregion 310-a may include multiple potential test locations (e.g., the corner points of the subregion 310-a). The network entity 105 may use a first beamforming vector for the first region 305-a based on a first steering direction 315-a corresponding to a first test location 320-a. The second region 305-b may include a subregion 310-b. The subregion 310-b may include multiple potential test locations (e.g., the corner points of the subregion 310-b). The network entity 105 may use a second beamforming vector for the second region 305-b based on a second steering direction 315-b corresponding to a second test location 320-b. Similarly, the third region 305-c may include the subregion 310-c, and the fourth region 305-d may include the subregion 310-d. The network entity 105 may use a third beamforming vector for the third region 305-c based on a third steering direction 315-c corresponding to a third test location 320-c, and the network entity 105 may use a fourth beamforming vector for the fourth region 305-d based on a fourth steering direction 315-d corresponding to a fourth test location 320-d.

A testing device may compute the EIRP mask based on an average of each of the possibilities (P) for steering directions. For example, the testing device may calculate the modified EIRP mask in accordance with Equation 2.

$$EIRP ( {θ}_{0} ) = \frac{1}{KNP} {\sum }_{k = 1}^{K} {\sum }_{n = 1}^{N} {\sum }_{p = 1}^{P} {w}_{nkp} * P ( {θ}_{0} , {φ}_{n} , {w}_{k}^{p} ) \qquad ( 2 )$$

In this example, the EIRP mask may be an average of the power over N azimuth angles (φₙ) with K beamforming vectors over P possible steering directions

$$( {w}_{k}^{p} ) .$$

The EIRP mask may be based on weights ( [symbol] ) associated with each beamforming vector in the EIRP computation. A default value for the weights ( [symbol] ) may be one for all n, k, and p.

Although initially described in the context of a rectangular region 305 and a rectangular subregion 310, the techniques described herein may be applied to any region or subregion shape (e.g., non-rectangular regions 305 or subregions 310 in the azimuth-elevation plane, such as elliptical regions 305 or subregions 310). In some examples, each region 305 may have a different type or shape of subregion 310. In some examples, each subregion 310 may include any quantity of possible steering directions 315 or test locations 320 (e.g., P may be any value). In some examples, each subregion 310 may include any quantity of possibilities of permutation of steering directions (e.g., the EIRP mask may be calculated based on a subset of test locations 320 (P′), where P′ is different than P).

The set of steering directions 315 within a region 305 may be a quasi-random set of steering directions 315 (e.g., steering vectors). For example, the set of steering directions 315 may be dynamic in time (e.g., the set of steering directions 315 may be valid for a first period of time and another set of steering directions 315 may be valid over a second period of time). The testing equipment may indicate the testing configuration (e.g., the region configuration, the subregion configuration, or the steering direction configuration) to the network entity 105 (e.g., potential aggressor node).

The EIRP mask may be used to verify cumulative or expected EIRP for any potential aggressor node (e.g., network entities 105, base stations, drones, unmanned aerial vehicles, customer premises equipment, or UEs 115) across any frequency band.

FIG. 4 shows an example of CAR 400-a, CAR 400-b, CAR 400-c, and CAR 400-d that supports beamforming vector power verification in accordance with one or more aspects of the present disclosure. In some examples, the CAR 400-a, the CAR 400-b, the CAR 400-c, or the CAR 400-d may implement aspects of, or be implemented by aspects of, the wireless communications system 100, the wireless communications system 200, or the CAR region configuration 300. For example, a network entity 105 may include the CAR 400-a, the CAR 400-b, the CAR 400-c, or the CAR 400-d. The network entity 105 may be an example of a network entity 105 as described with reference to FIGS. 1-3. As illustrated in FIG. 4, the CAR 400-a, the CAR 400-b, the CAR 400-c, and the CAR 400-d may include four possible steering directions (P=4) over fifteen regions (K=15) of the CAR. The CAR 400-a, the CAR 400-b, the CAR 400-c, and the CAR 400-d may illustrate a same CAR at different time periods.

The network entity 105 may transmit a beam in accordance with a beamforming vector at each region of the CAR. During a first duration associated with the CAR 400-a, the network entity 105 may transmit a beam in accordance with a steering direction 405-a at a first test location of a first region of the CAR 400-a. The network entity 105 may subsequently transmit a beam at a respective test location of each region of the CAR 400-a. As illustrated in FIG. 4, the adjacent regions may sequentially iterate through the set of test locations.

The network entity 105 may transmit a beam at each test location of the set of test locations within each region. For example, at a second duration associated with the CAR 400-b, the network entity 105 may transmit a second beam in accordance with a steering direction 405-b at a second test location of the first region of the CAR. The network entity 105 may subsequently transmit a beam at a second test location of each region of the CAR. Similarly, the network entity 105 may transmit a third beam in accordance with a steering direction 405-c during a duration associated with the CAR 400-c, and the network entity 105 may transmit a fourth beam in accordance with a steering direction 405-d during a duration associated with the CAR 400-d.

A testing device may measure the EIRP mask in accordance with the multiple beams transmitted at each region and in accordance with each test location as described in Equation 2.

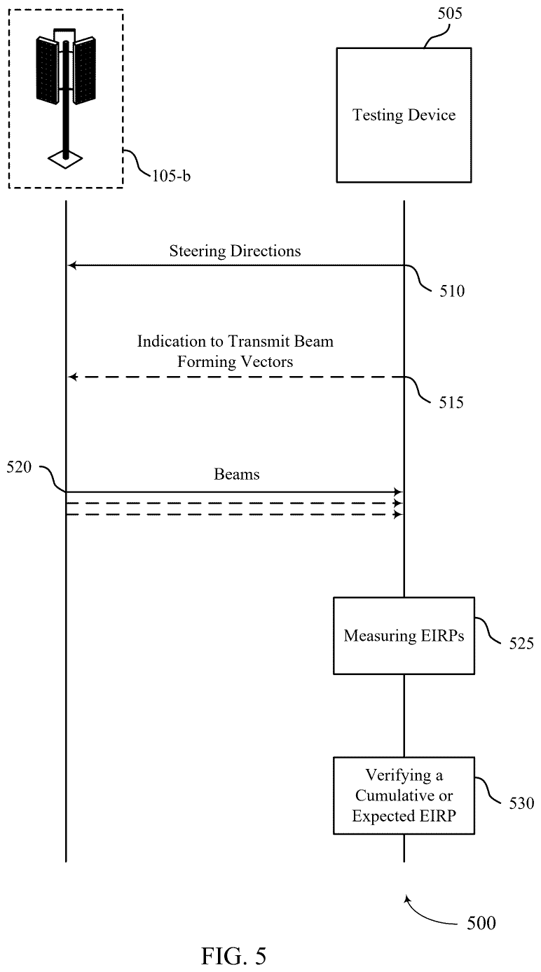

FIG. 5 shows an example of a process flow 500 that supports beamforming vector power verification in accordance with one or more aspects of the present disclosure. In some examples, process flow 500 may implement aspects of, or be implemented by aspects of, the wireless communications system 100, the wireless communications system 200, the CAR region configuration 300, the CAR 400-a, the CAR 400-b, the CAR 400-c, or the CAR 400-d. For example, the process flow 500 may include a network entity 105-b and a testing device 505 which may be examples of corresponding devices described with reference to FIGS. 1-4D.

At 510, the testing device 505 may output an indication of multiple steering directions to the network entity 105-b. Multiple beamforming vectors corresponding to regions within a CAR of the network entity may be based on the multiple steering directions. For each region, a respective steering direction of the plurality of steering directions may be determined from a respective test location selected from a set of test locations on a perimeter of a subregion within each region.

In some cases, the subregion within each region may be a rectangular region. The set of test locations may be located in multiple corners associated with the rectangular region. In some cases, the subregion within each region may be a curved region (e.g., an elliptical region). In some cases, a first region of the regions may include a first subregion shape, and a second region of the regions may include a second subregion shape.

In some cases, adjacent regions within a dimension of the regions of the CAR may traverse a sequential order of the set of test locations (e.g., as illustrated in FIG. 4). The respective test location associated with the respective steering direction may be selected from the set of test locations pseudo-randomly. In some cases, the multiple steering directions may include a first set of steering directions during a first duration, and the multiple steering directions may include a second set of steering directions during a second duration.

At 515, the testing device 505 may output an indication for the network entity 105-b to transmit according to the multiple beamforming vectors.

At 520, the network entity 105-b may transmit multiple beams in accordance with the multiple beamforming vectors over each region within the CAR. In some examples, the network entity 105-b may transmit the multiple beams in response to the indication for the network entity 105-b to transmit according to the multiple beamforming vectors.

At 525, the testing device 505 may measure one or more EIRPs of the multiple beams over an elevation or an azimuth angle associated with the plurality of beamforming vectors.

At 530, the testing device 505 may verify that a cumulative or expected EIRP of the multiple beams satisfies a EIRP envelope or mask associated with the elevation or the azimuth angle. For example, the testing device 505 may calculate an EIRP mask in accordance with Equation 2. In some cases, the cumulative or expected EIRP may be a weighted average of the one or more EIRPs associated with the multiple beamforming vectors.

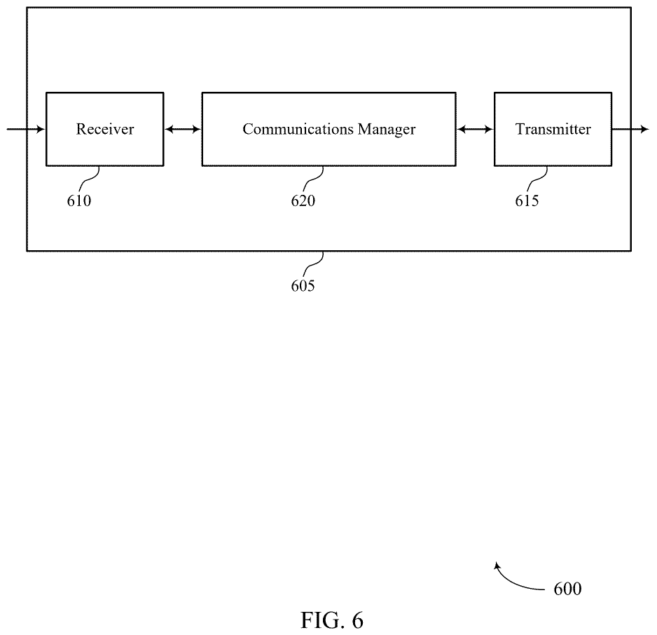

FIG. 6 shows a block diagram 600 of a device 605 that supports beamforming vector power verification in accordance with one or more aspects of the present disclosure. The device 605 may be an example of aspects of a testing device as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to beamforming vector power verification). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to beamforming vector power verification). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of beamforming vector power verification as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support testing a network entity in accordance with examples as disclosed herein. For example, the communications manager 620 is capable of, configured to, or operable to support a means for outputting an indication of a set of multiple steering directions to the network entity, where a set of multiple beamforming vectors corresponding to regions within a CAR of the network entity are based on the set of multiple steering directions, and where, for each region, a respective steering direction of the set of multiple steering directions is determined from a respective test location selected from a set of test locations on a perimeter of a subregion within each region. The communications manager 620 is capable of, configured to, or operable to support a means for measuring one or more EIRPs of beams over an elevation or an azimuth angle associated with the set of multiple beamforming vectors. The communications manager 620 is capable of, configured to, or operable to support a means for verifying that a cumulative or expected EIRP of the beams satisfies a EIRP envelope or mask associated with the elevation or the azimuth angle.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources and the like.

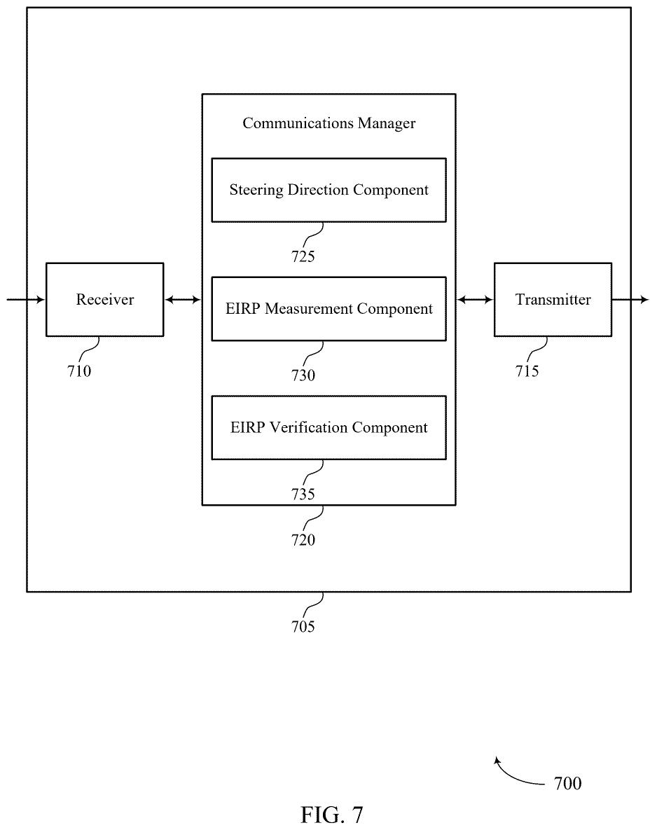

FIG. 7 shows a block diagram 700 of a device 705 that supports beamforming vector power verification in accordance with one or more aspects of the present disclosure. The device 705 may be an example of aspects of a device 605 or a testing device as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to beamforming vector power verification). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to beamforming vector power verification). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of beamforming vector power verification as described herein. For example, the communications manager 720 may include a steering direction component 725, an EIRP measurement component 730, an EIRP verification component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support testing a network entity in accordance with examples as disclosed herein. The steering direction component 725 is capable of, configured to, or operable to support a means for outputting an indication of a set of multiple steering directions to the network entity, where a set of multiple beamforming vectors corresponding to regions within a CAR of the network entity are based on the set of multiple steering directions, and where, for each region, a respective steering direction of the set of multiple steering directions is determined from a respective test location selected from a set of test locations on a perimeter of a subregion within each region. The EIRP measurement component 730 is capable of, configured to, or operable to support a means for measuring one or more EIRPs of beams over an elevation or an azimuth angle associated with the set of multiple beamforming vectors. The EIRP verification component 735 is capable of, configured to, or operable to support a means for verifying that a cumulative or expected EIRP of the beams satisfies a EIRP envelope or mask associated with the elevation or the azimuth angle.

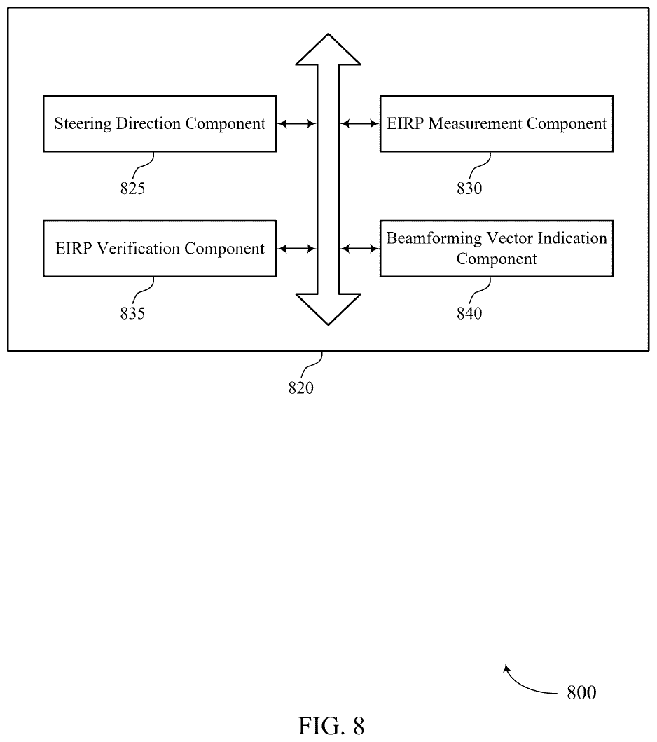

FIG. 8 shows a block diagram 800 of a communications manager 820 that supports beamforming vector power verification in accordance with one or more aspects of the present disclosure. The communications manager 820 may be an example of aspects of a communications manager 620, a communications manager 720, or both, as described herein. The communications manager 820, or various components thereof, may be an example of means for performing various aspects of beamforming vector power verification as described herein. For example, the communications manager 820 may include a steering direction component 825, an EIRP measurement component 830, an EIRP verification component 835, a beamforming vector indication component 840, or any combination thereof. Each of these components, or components or subcomponents thereof (e.g., one or more processors, one or more memories), may communicate, directly or indirectly, with one another (e.g., via one or more buses).

The communications manager 820 may support testing a network entity in accordance with examples as disclosed herein. The steering direction component 825 is capable of, configured to, or operable to support a means for outputting an indication of a set of multiple steering directions to the network entity, where a set of multiple beamforming vectors corresponding to regions within a CAR of the network entity are based on the set of multiple steering directions, and where, for each region, a respective steering direction of the set of multiple steering directions is determined from a respective test location selected from a set of test locations on a perimeter of a subregion within each region. The EIRP measurement component 830 is capable of, configured to, or operable to support a means for measuring one or more EIRPs of beams over an elevation or an azimuth angle associated with the set of multiple beamforming vectors. The EIRP verification component 835 is capable of, configured to, or operable to support a means for verifying that a cumulative or expected EIRP of the beams satisfies a EIRP envelope or mask associated with the elevation or the azimuth angle.

In some examples, the beamforming vector indication component 840 is capable of, configured to, or operable to support a means for outputting an indication for the network entity to transmit the set of multiple beamforming vectors.

In some examples, the subregion within each region is a rectangular region.

In some examples, the set of test locations are located in a set of multiple corners associated with the rectangular region.

In some examples, the subregion within each region is a curved region.

In some examples, adjacent regions within a dimension of the regions of the CAR traverse a sequential order of the set of test locations.

In some examples, for each region, the respective test location associated with the respective steering direction is selected from the set of test locations pseudo-randomly.

In some examples, the cumulative or expected EIRP is a weighted average of the one or more EIRPs associated with the set of multiple beamforming vectors.

In some examples, a first region of the regions includes a first subregion shape, and a second region of the regions includes a second subregion shape.

In some examples, the set of multiple steering directions include a first set of steering directions during a first duration, and the set of multiple steering directions include a second set of steering directions during a second duration.

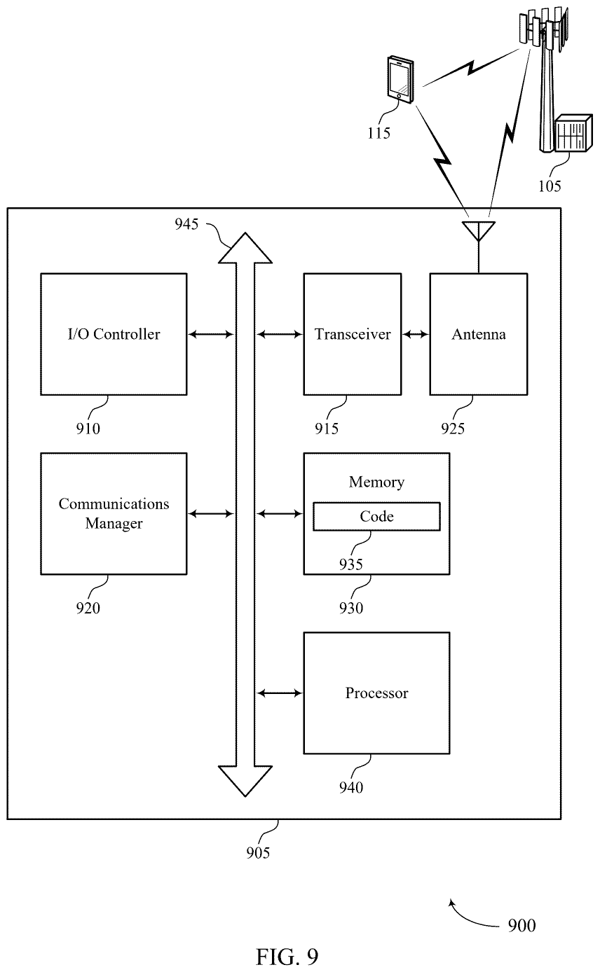

FIG. 9 shows a diagram of a system 900 including a device 905 that supports beamforming vector power verification in accordance with one or more aspects of the present disclosure. The device 905 may be an example of or include components of a device 605, a device 705, or a testing device as described herein. The device 905 may include components for bi-directional voice and data communications including components for transmitting and receiving communications, such as a communications manager 920, an I/O controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include RAM and ROM. The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a BIOS which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting beamforming vector power verification). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support testing a network entity in accordance with examples as disclosed herein. For example, the communications manager 920 is capable of, configured to, or operable to support a means for outputting an indication of a set of multiple steering directions to the network entity, where a set of multiple beamforming vectors corresponding to regions within a CAR of the network entity are based on the set of multiple steering directions, and where, for each region, a respective steering direction of the set of multiple steering directions is determined from a respective test location selected from a set of test locations on a perimeter of a subregion within each region. The communications manager 920 is capable of, configured to, or operable to support a means for measuring one or more EIRPs of beams over an elevation or an azimuth angle associated with the set of multiple beamforming vectors. The communications manager 920 is capable of, configured to, or operable to support a means for verifying that a cumulative or expected EIRP of the beams satisfies a EIRP envelope or mask associated with the elevation or the azimuth angle.

By including or configuring the communications manager 920 in accordance with examples as described herein, the device 905 may support techniques for improved communication reliability, more efficient utilization of communication resources, improved coordination between devices, and the like.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of beamforming vector power verification as described herein, or the at least one processor 940 and the at least one memory 930 may be otherwise configured to, individually or collectively, perform or support such operations.

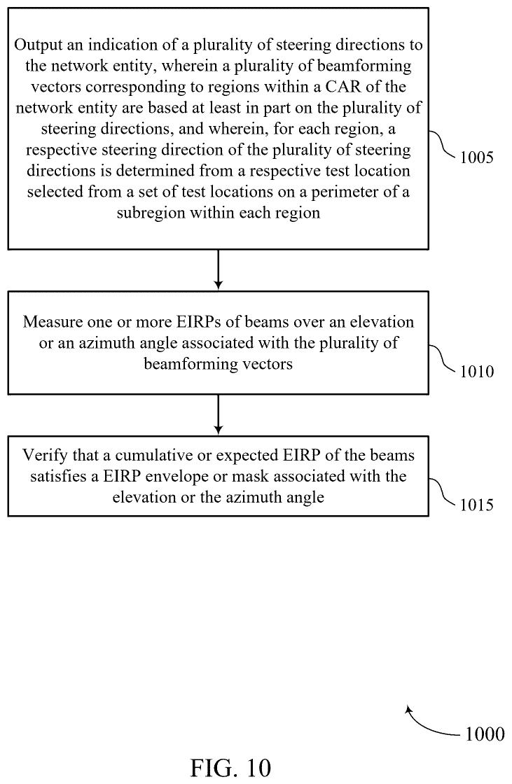

FIG. 10 shows a flowchart illustrating a method 1000 that supports beamforming vector power verification in accordance with one or more aspects of the present disclosure. The operations of the method 1000 may be implemented by a testing device or its components as described herein. For example, the operations of the method 1000 may be performed by a testing device as described with reference to FIGS. 1 through 9. In some examples, a testing device may execute a set of instructions to control the functional elements of the testing device to perform the described functions. Additionally, or alternatively, the testing device may perform aspects of the described functions using special-purpose hardware.

At 1005, the method may include outputting an indication of a plurality of steering directions to the network entity, wherein a plurality of beamforming vectors corresponding to regions within a CAR of the network entity are based at least in part on the plurality of steering directions, and wherein, for each region, a respective steering direction of the plurality of steering directions is determined from a respective test location selected from a set of test locations on a perimeter of a subregion within each region. The operations of 1005 may be performed in accordance with examples as disclosed herein. In some examples, aspects of the operations of 1005 may be performed by a steering direction component 825 as described with reference to FIG. 8.

At 1010, the method may include measuring one or more EIRPs of beams over an elevation or an azimuth angle associated with the plurality of beamforming vectors. The operations of 1010 may be performed in accordance with examples as disclosed herein. In some examples, aspects of the operations of 1010 may be performed by an EIRP measurement component 830 as described with reference to FIG. 8.

At 1015, the method may include verifying that a cumulative or expected EIRP of the beams satisfies a EIRP envelope or mask associated with the elevation or the azimuth angle. The operations of 1015 may be performed in accordance with examples as disclosed herein. In some examples, aspects of the operations of 1015 may be performed by an EIRP verification component 835 as described with reference to FIG. 8.

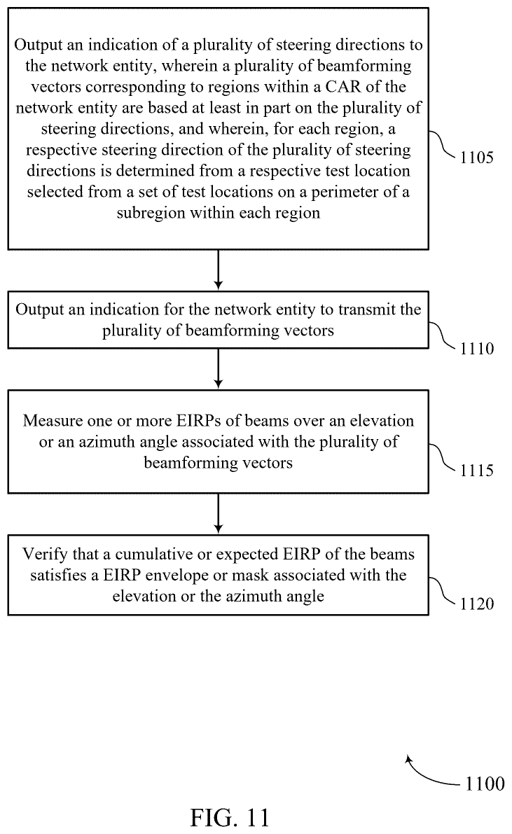

FIG. 11 shows a flowchart illustrating a method 1100 that supports beamforming vector power verification in accordance with one or more aspects of the present disclosure. The operations of the method 1100 may be implemented by a testing device or its components as described herein. For example, the operations of the method 1100 may be performed by a testing device as described with reference to FIGS. 1 through 9. In some examples, a testing device may execute a set of instructions to control the functional elements of the testing device to perform the described functions. Additionally, or alternatively, the testing device may perform aspects of the described functions using special-purpose hardware.

At 1105, the method may include outputting an indication of a plurality of steering directions to the network entity, wherein a plurality of beamforming vectors corresponding to regions within a CAR of the network entity are based at least in part on the plurality of steering directions, and wherein, for each region, a respective steering direction of the plurality of steering directions is determined from a respective test location selected from a set of test locations on a perimeter of a subregion within each region. The operations of 1105 may be performed in accordance with examples as disclosed herein. In some examples, aspects of the operations of 1105 may be performed by a steering direction component 825 as described with reference to FIG. 8.

At 1110, the method may include outputting an indication for the network entity to transmit the plurality of beamforming vectors. The operations of 1110 may be performed in accordance with examples as disclosed herein. In some examples, aspects of the operations of 1110 may be performed by a beamforming vector indication component 840 as described with reference to FIG. 8.

At 1115, the method may include measuring one or more EIRPs of beams over an elevation or an azimuth angle associated with the plurality of beamforming vectors. The operations of 1115 may be performed in accordance with examples as disclosed herein. In some examples, aspects of the operations of 1115 may be performed by an EIRP measurement component 830 as described with reference to FIG. 8.

At 1120, the method may include verifying that a cumulative or expected EIRP of the beams satisfies a EIRP envelope or mask associated with the elevation or the azimuth angle. The operations of 1120 may be performed in accordance with examples as disclosed herein. In some examples, aspects of the operations of 1120 may be performed by an EIRP verification component 835 as described with reference to FIG. 8.

The following provides an overview of aspects of the present disclosure:

Aspect 1: A method by an apparatus, comprising: outputting an indication of a plurality of steering directions to a network entity, wherein a plurality of beamforming vectors corresponding to regions within a CAR of the network entity are based at least in part on the plurality of steering directions, and wherein, for each region, a respective steering direction of the plurality of steering directions is determined from a respective test location selected from a set of test locations on a perimeter of a subregion within each region; measuring one or more EIRPs of beams over an elevation or an azimuth angle associated with the plurality of beamforming vectors; and verifying that a cumulative or expected EIRP of the beams satisfies a EIRP envelope or mask associated with the elevation or the azimuth angle.

Aspect 2: The method of aspect 1, further comprising: outputting an indication for the network entity to transmit the plurality of beamforming vectors.

Aspect 3: The method of any of aspects 1 through 2, wherein the subregion within each region is a rectangular region.

Aspect 4: The method of aspect 3, wherein the set of test locations are located in a plurality of corners associated with the rectangular region.

Aspect 5: The method of any of aspects 1 through 2, wherein the subregion within each region is a curved region.

Aspect 6: The apparatus of any of aspects 1 through 5, wherein adjacent regions within a dimension of the regions of the CAR traverse a sequential order of the set of test locations.

Aspect 7: The method of any of aspects 1 through 6, wherein for the each region, the respective test location associated with the respective steering direction is selected from the set of test locations pseudo-randomly.

Aspect 8: The method of any of aspects 1 through 7, wherein the cumulative or expected EIRP is a weighted average of the one or more EIRPs associated with the plurality of beamforming vectors.

Aspect 9: The method of any of aspects 1 through 8, wherein a first region of the regions comprises a first subregion shape, and a second region of the regions comprises a second subregion shape.

Aspect 10: The method of any of aspects 1 through 9, wherein the plurality of steering directions comprise a first set of steering directions during a first duration, and the plurality of steering directions comprise a second set of steering directions during a second duration.

Aspect 11: An apparatus comprising one or more memories storing processor-executable code, and one or more processors coupled with the one or more memories and individually or collectively operable to execute the code to cause the apparatus to perform a method of any of aspects 1 through 10.

Aspect 12: An apparatus comprising at least one means for performing a method of any of aspects 1 through 10.

Aspect 13: A non-transitory computer-readable medium storing code the code comprising instructions executable by one or more processors to perform a method of any of aspects 1 through 10.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
output an indication of a plurality of steering directions to a network entity, wherein a plurality of beamforming vectors corresponding to regions within a coverage angular region of the network entity are based at least in part on the plurality of steering directions, and wherein, for each region, a respective steering direction of the plurality of steering directions is determined from a respective test location selected from a set of test locations on a perimeter of a subregion within each region;
measure one or more effective isotropic radiated powers (EIRPs) of beams over an elevation or an azimuth angle associated with the plurality of beamforming vectors; and
verify that a cumulative or expected EIRP of the beams satisfies a EIRP envelope or mask associated with the elevation or the azimuth angle.

2. The apparatus of claim 1, wherein the one or more processors are individually or collectively further operable to execute the code to cause the apparatus to:
output an indication for the network entity to transmit the plurality of beamforming vectors.

3. The apparatus of claim 1, wherein the subregion within each region is a rectangular region.

4. The apparatus of claim 3, wherein the set of test locations are located in a plurality of corners associated with the rectangular region.

5. The apparatus of claim 1, wherein the subregion within each region is a curved region.

6. The apparatus of claim 1, wherein:
adjacent regions within a dimension of the regions of the coverage angular region traverse a sequential order of the set of test locations.

7. The apparatus of claim 1, wherein, for each region, the respective test location associated with the respective steering direction is selected from the set of test locations pseudo-randomly.

8. The apparatus of claim 1, wherein the cumulative or expected EIRP is a weighted average of the one or more EIRPs associated with the plurality of beamforming vectors.

9. The apparatus of claim 1, wherein a first region of the regions comprises a first subregion shape, and a second region of the regions comprises a second subregion shape.

10. The apparatus of claim 1, wherein the plurality of steering directions comprise a first set of steering directions during a first duration, and the plurality of steering directions comprise a second set of steering directions during a second duration.

11. A method for testing a network entity, comprising:
outputting an indication of a plurality of steering directions to the network entity, wherein a plurality of beamforming vectors corresponding to regions within a coverage angular region of the network entity are based at least in part on the plurality of steering directions, and wherein, for each region, a respective steering direction of the plurality of steering directions is determined from a respective test location selected from a set of test locations on a perimeter of a subregion within each region;
measuring one or more effective isotropic radiated powers (EIRPs) of beams over an elevation or an azimuth angle associated with the plurality of beamforming vectors; and
verifying that a cumulative or expected EIRP of the beams satisfies a EIRP envelope or mask associated with the elevation or the azimuth angle.

12. The method of claim 11, further comprising:
outputting an indication for the network entity to transmit the plurality of beamforming vectors.

13. The method of claim 11, wherein the subregion within each region is a rectangular region.

14. The method of claim 13, wherein the set of test locations are located in a plurality of corners associated with the rectangular region.

15. The method of claim 11, wherein the subregion within each region is a curved region.

16. The method of claim 11, wherein adjacent regions within a dimension of the regions of the coverage angular region traverse a sequential order of the set of test locations.

17. The method of claim 11, wherein, for each region, the respective test location associated with the respective steering direction is selected from the set of test locations pseudo-randomly.

18. The method of claim 11, wherein the cumulative or expected EIRP is a weighted average of the one or more EIRPs associated with the plurality of beamforming vectors.

19. The method of claim 11, wherein a first region of the regions comprises a first subregion shape, and a second region of the regions comprises a second subregion shape.

20. A non-transitory computer-readable medium storing code for testing a network entity, the code comprising instructions stored in one or more memories and executable by one or more processors to:
output an indication of a plurality of steering directions to the network entity, wherein a plurality of beamforming vectors corresponding to regions within a coverage angular region of the network entity are based at least in part on the plurality of steering directions, and wherein, for each region, a respective steering direction of the plurality of steering directions is determined from a respective test location selected from a set of test locations on a perimeter of a subregion within each region;
measure one or more effective isotropic radiated powers (EIRPs) of beams over an elevation or an azimuth angle associated with the plurality of beamforming vectors; and
verify that a cumulative or expected EIRP of the beams satisfies a EIRP envelope or mask associated with the elevation or the azimuth angle.
